(19) United States
(12) Patent Application Publication
(10) Pub. No.: US 2009/0202422 A1
(43) Pub. Date: Aug. 13, 2009

(54) METHOD FOR TREATING CARBON NANOTUBES, CARBON NANOTUBES AND CARBON NANOTUBE DEVICE

(75) Inventors: Hisashi Kajiura, Tokyo (JP); Yongming Li, Tokyo (JP); Lei Fu, Beijing (CN); Yunqi Liu, Beijing (CN); Xianglong Li, Beijing (CN); Lingchao Cao, Beijing (CN); Dacheng Wei, Beijing (CN); Yu Wang, Beijing (CN); Gui Yu, Beijing (CN)

Correspondence Address: K&L Gates LLP, P. O. BOX 1135, CHICAGO, IL, 60690, US

(73) Assignee: Sony Corporation, Tokyo (JP)

(21) Appl. No.: 12/269,999

(22) Filed: Nov. 13, 2008

(30) Foreign Application Priority Data
Nov. 29, 2007 (CN) 200710196652.7

(51) Int. Cl. C01B 31/00; D01F 9/12; C01B 31/02

(52) U.S. Cl. 423/447.2; 423/447.1; 977/742

(57) ABSTRACT

A method for treating carbon nanotubes is proved, which comprises treating the carbon nanotubes with an aqueous solution containing hydroxyl radicals (HO.).

### CROSS REFERENCES TO RELATED APPLICATIONS

The present application claims priority to Chinese Patent Application CN 200710196652.7 filed in the Chinese Patent Office on Nov. 29, 2007, the entire contents of which is being incorporated herein by reference.

### BACKGROUND

The present application relates to a method for treating carbon nanotubes (CNTs), CNTs obtained, and a CNT device using the CNTs obtained.

As one-dimensional nano-material, CNTs are of many excellent electrical, mechanical, and chemical properties, and therefore have attracted increasing attention. With the continuing study on this nano-material, the widespread application prospects for the CNTs are continuously arising. For example, CNTs can be applied in the fields of electronics, optics, mechanics, biotechnology, and ecology, and used in, for example, a nano-field effect transistor, a field emission source, a hydrogen storage material, a high strength fiber, a sensor, and the like.

CNTs can be classified as single-walled carbon nanotubes (SWNTs) and multi-walled carbon nanotubes (MWNTs) according to the number of the atomic layers forming the wall thereof, in which the MWNTs may be considered as being formed by nesting the SWNTs with different diameters. In research and application, the SWNTs and the MWNTs with relatively small number of atomic layers are of importance due to the outstanding performance.

CNTs can also be classified as metallic CNTs and semiconducting CNTs according to their conductivity, in which the former for example can be used for field emission source, electrode materials and the like, and the latter for example can be used for nano-filed effect transistors, sensors and the like. In Saito R et al, Material Science and Engineering, 1993, B19: 185 to 191, Saito et al. have through theoretical analysis concluded that according to the diameter and chiral angle of the SWNTs, about ⅓ of SWNTs are metallic and the other ⅔ are semiconducting. Due to the various preparing condition, purifying treatment and the like, the ratio of the two types of CNTs may not be strictly consistent with the above theoretical value in the actual resulting product. With the increase of the number of the carbon atomic walls, the metallicity of the CNTs gradually increases and at last the CNTs become pure metallic.

The conventional methods for preparing the CNTs include graphite arc-discharging, chemical vapor deposition, laser evaporation and the like. The CNTs obtained through these methods normally include both metallic CNTs and semiconducting CNTs, which are mixed together. Therefore, one of the prerequisite for the metallic and semiconducting CNTs being put into application is to separate the CNTs with different conductivity from each other in the prepared product. Hence, the separation of the CNTs has become one of the important topics in the research.

Currently, many methods using the difference in chemical and physical properties between the metallic and semiconducting CNTs to separate CNTs have been proposed.

In “Selective Oxidation of Semiconducting Single-Wall Carbon Nanotubes by Hydrogen Peroxide”, Yasumitsu Miyata et al, J. Phys. Chem. B; 2006; 110(1) pp 25-29 (Letter) (hereinafter referred to non-patent document 1) and in the Japanese Patent Laid-Open Publication JP2006-188380A (hereinafter referred to patent document 1), there is disclosed a method to enrich the metallic SWNTs by treating the SWNTs with a hydrogen peroxide (H₂O₂) aqueous solution.

In the method of the non-patent document 1, the HiPco (high pressure carbon monoxide method)-SWNTs prepared through the decomposition of carbon monoxide in high pressure with Fe nanoparticles as catalyst by Carbon Nanotechnologies Inc. (USA) are used. The HiPco-SWNTs are put into the H₂O₂ aqueous solution and a heat treatment is performed at 90° C. After the heat treatment for 47 minutes, 99% of the SWNTs are decomposed. The analysis result for the remaining 1% of SWNTs shows that the ratio of metallic SWNTs therein is increased up to about 80%.

The non-patent document 1 has shown that the reactivity of the semiconducting SWNTs is higher than that of the metallic SWNTs and thus the semiconducting SWNTs can be selectively removed from the metallic SWNTs by using this difference in reactivity. In the past, the general point of view is that the reactivity of the metallic SWNTs should be higher than that of the semiconducting SWNTs, however, the result of the above method shows the contrary case. For this, the possible reason is that the weak hole-doping effect of H₂O₂ makes the density of state (DOS) of the Fermi energy structure of the semiconducting SWNTs higher than that of the metallic SWNTs, and therefore makes the reactivity of the semiconducting SWNTs higher than that of the metallic SWNTs. In the reaction, the oxidation of SWNTs by H₂O₂ is performed in two stages: in the first stage, SWNTs are activated through the oxidation reaction to obtain oxygen from H₂O₂; in the second stage, the active oxygen is generated by H₂O₂, and the activated SWNTs are subject to oxidation and decomposition and are transformed into carbon dioxide (CO₂).

Non-patent document 1: Yasumitsu Miyata et al, J. Phys. Chem. B; 2006; 110(1) pp 25-29 (Letter); and

Patent document 1: JP2006-188380A

### SUMMARY

However, when the method disclosed in the non-patent document 1 is used to treat CNTs so as to separate the metallic CNTs, the yield is very low (only about 1%) and the ratio of metallic CNTs needs to be further increased. Therefore, there are still needs for a new method to treat the CNTs to effectively modify the characteristics of the CNTs, for example, the method to separate the metallic and the semiconducting CNTs.

The present application provides, in an embodiment, a method of treating CNTs, wherein the CNTs are treated with an aqueous solution containing hydroxyl radicals (HO.).

Preferably, the hydroxyl radicals (HO.) may be obtained by decomposing hydrogen peroxide (H₂O₂) dissolved in the aqueous solution.

Preferably, low valent metal ions may be used as catalyst to decompose the hydrogen peroxide (H₂O₂) resolved in the aqueous solution to produce the hydroxyl radicals (HO.). More preferably, the low valent metal ions comprise the bivalent ions of Fe, Co, or Ni. The low valent ions may be directly added into the H₂O₂ solution via their aqueous solution, or may be obtained by adding the oxide or the simple substance of the metal into the H₂O₂ solution to have it react with the H⁺ contained in the solution, for example.

Preferably, the low valent metal ions in the aqueous solution may have the concentration of 0.0001 mol/L to 0.01 mol/L.

The aqueous solution may be an acidic or neutral solution, and more preferably the solution is acidic, and the pH value may be less than 6, for example 2 or 3. The pH value may be adjusted by adding water, acid such as H₂SO₄, HCl and HNO₃ or alkali such as NaOH into the solution.

Preferably, the hydrogen peroxide (H₂O₂) in the aqueous solution may have the concentration of 1 wt % to 30 wt %.

Preferably, the above described treating method may be performed at the temperature below the boiling point of the aqueous solution, more preferably at the temperature from room temperature to 100 degree Celsius, for example, at 70 degree Celsius.

Preferably, additional H₂O₂ is added to the aqueous solution at a predetermined interval to keep the content of the hydroxyl radicals in the aqueous solution.

The method of treating the CNTs according to an embodiment is applicable to single-walled or multi-walled CNTs, preferably the single-walled CNTs, double-walled CNTs and other multi-walled CNTs with relatively small number of walls.

The method of treating the CNTs according to an embodiment can effectively enrich the metallic CNTs in the treated CNTs and obtain high yield. On the other hand, the method of treating the CNTs according to an embodiment can reduce or substantially remove the impurities such as amorphous carbon, carbon nanoparticles and the like which may be contained in the CNTs.

In another embodiment, the present application provides the CNTs treated with an aqueous solution containing hydroxyl radicals (HO.). Comparing with the CNTs prior to the treatment, in the CNTs according to an embodiment, the impurities such as amorphous carbon, carbon nanoparticles and the like can be reduced or substantially removed, the proportion of the metallic CNTs therein can be increased, and the CNTs with relatively large diameter can be enriched.

In yet another embodiment, the present application provides a CNT device, which comprises the CNTs treated with an aqueous solution containing hydroxyl radicals (HO.).

Preferably, the CNT device includes, for example, a CNT conductive film, a field emission source, a transistor, a conductive wire, a electrode material (e.g., transparent, porous or gas diffusing electrode material), a nano electro-mechanic system (NEMS), a nano cantilever, a quantum computing device, a lighting emitting diode, a solar cell, a surface-conduction electron-emitter display, a filter (e.g., high-frequency or photonic band), a drag delivery system, a thermal conductive material, a nano nozzle, an energy storage material (e.g., hydrogen storage material), a fuel cell, a sensor (e.g., a gas, glucose, or ion sensor), or a catalyst support material.

Additional features and advantages are described herein, and will be apparent from the following Detailed Description and the figures.

### BRIEF DESCRIPTION OF THE FIGURES

FIGS. 1A and 1B show the SEM photos of starting SWNTs and SWNTs which are treated with H₂O₂ and H₂SO₄ for 2 hours at 70 degree Celsius, respectively.

FIG. 2A shows the visible-near-infrared (vis-NIR) absorption spectra of the starting SWNTs and the SWNTs which are treated with H₂O₂ and H₂SO₄ for 2 hours at 70 degree Celsius.

FIGS. 2B and 2C show the Raman spectra of the starting SWNTs and the SWNTs which are treated with H₂O₂ and H₂SO₄ for 2 hours at 70 degree Celsius.

FIG. 3 is the Raman spectra of the sample treated in a single step treatment for 4 hours.

FIG. 4 is the change of the content of the metallic CNTs in the sample treated in the single step treatment with the time.

FIG. 5 is the Raman spectra of the sample after adding H₂O₂ and H₂SO₄ for 3 times in a multiple step treatment.

FIG. 6 is the change of the content of the metallic CNTs in the sample treated in a multiple step treatment with the time.

### DETAILED DESCRIPTION

An embodiment of the present application will be described with reference to the drawings.

Hydroxyl radicals (HO.) are known to be one type of high active oxidizing radical, and its standard potential (2.80 V) is only below that of fluorine (F) (2.87 V), and thereby it has the oxidizability only below that of fluorine. Currently, hydroxyl radicals (HO.) are widely used to oxidize organic substances, for example, to treat the wastewater and the like which are abundant in various organic substances. However, according to the knowledge of the inventors, there is not a method of treating CNTs with hydroxyl radicals (HO.) to modify the characteristic of the CNTs yet.

In an embodiment, the CNTs are treated using the aqueous solution containing hydroxyl radicals (HO.). The treated CNTs may be SWNTs, double-walled carbon nanotubes (DWNTs) or other MWNTs. In the CNTs treated by the method of an embodiment, the impurities such as amorphous carbon, carbon nanoparticles and the like can be reduced or substantially removed, and the ratio of the metallic CNTs can be increased, and furthermore the ratio of the CNTs with relatively large diameter can be enriched.

It is known that there are a variety of methods to obtain the aqueous solution of hydroxyl radicals, such as electron radiation, water motivation, photocatalysis, and hydrogen peroxide methods, for example, the photocatalysis systems of UV (ultraviolet)/H₂O₂, UV/O₃, UV/TiO₂ or the method of decomposing H₂O₂ resolved in water (or the aqueous solution of H₂O₂) with catalyst. These methods in the related art can be used in an embodiment. The method of treating CNTs using the aqueous solution containing hydroxyl radicals according to an embodiment is not limited to the method of generating the aqueous solution containing hydroxyl radicals.

In the above methods, the method of decomposing H₂O₂ dissolved in water using catalyst is relatively easier to realize. It is known that hydrogen peroxide is a strong oxidation agent. H₂O₂ is still not used to obtain hydroxyl radicals to treat CNTs according to the knowledge of the inventors. The catalyst which is used to decompose H₂O₂ dissolved in water includes low valent metal ions. The low valent metal ions may be the low valent ions of transition metal, for example the bivalent ions of Fe, Co, Ni and the like. The combination of H₂O₂ and bivalent Fe ions (Fe²⁺) is usually referred to Fenton agent.

H₂O₂ can decompose exothermically into water and oxygen gas spontaneously with the following equation (1), and generates heat of ΔG^{θ} of −119.2 kJ·mol⁻¹. The rate of the decomposition is dependent on the temperature and the concentration of the peroxide, as well as the pH value and the presence of impurities and stabilizers. Hydrogen peroxide is incompatible with many kinds of substance that may function as catalyze for the decomposition, including most of the transition metals and their compounds.

2H₂O₂→2H₂O+O₂ (1)

However, in the presence of certain catalyst, such as Fe²⁺ or Fe³⁺, the decomposition takes a different path with the following equations (2) and (3), in which the free radicals of HO. and HOO. are formed:

Fe²⁺+H₂O₂→Fe³⁺+.OH+OH⁻ (2)

Fe³⁺+H₂O₂→Fe²⁺+.OOH+H⁺ (3)

When Fe²⁺ is introduced into the aqueous solution of H₂O₂, the Fe²⁺ will invoke the above chain reaction of the equations (2) and (3), and HO. free radicals are generated in water and HOO. free radicals are obtained at the same time, which makes the decomposition of H₂O₂ is in the path of generating HO. and HOO. free radicals rather than that of the above equation (1) directly. Furthermore, it is also known from equation (3) that, even if Fe³⁺ is added at the beginning, Fe²⁺ serving as catalyst for generating HO. may be obtained through an oxidation-reduction reaction. Other catalyst metal ions can lead to similar reaction.

### The First Embodiment

The first embodiment of the present application provides a method for treating CNTs, in which the low valent metal ions are used as catalyst for decomposing H₂O₂ resolved in water to obtain the aqueous solution containing hydroxyl radicals, and then the CNTs are treated with such aqueous solution.

The aqueous solution containing hydroxyl radicals may be obtained by introducing low valent metal ions as catalyst into the aqueous solution of H₂O₂. The aqueous solution of H₂O₂ may be commercial available product (for example the content thereof is 30 wt %), or can be obtained by the reaction between peroxide (e.g., calcium peroxide (CaO₂) or sodium peroxide (Na₂O₂) and the like) and water, or other methods to obtain H₂O₂. The present embodiment is not limited to the methods to obtain the aqueous solution of H₂O₂.

The introduction of low valent metal ions may be performed by adding the water-soluble salt of the metal ions or the aqueous solution of the salt into the aqueous solution of H₂O₂. In the case that the aqueous solution is acidic, the simple substance or oxide of the metal may be added into the aqueous solution of H₂O₂, or the high valent metal ions are added and these high valent metal ions will react with H₂O₂ to generate low valent ions thereof. For example, in the case that the low valent metal ions are ferrous ions (Fe²⁺), solid FeSO₄ or the aqueous solution of FeSO₄ can be added into the aqueous solution, or Fe simple substance (for example, iron powders) or ferrous oxide (FeO) is added into the acidic aqueous solution obtained from the mixture of the aqueous solution of H₂O₂ and the acid such as H₂SO₄, HCl or HNO₃, and Fe²⁺ is obtained by the reaction between Fe or its ferrous oxide and the acid. In addition, as described above, ferric ions (Fe³⁺) may be added and then the Fe³⁺ ions react with H₂O₂ and are reduced to Fe²⁺, and all these forms may be used to introduce ferrous ions used as catalyst into the aqueous solution of H₂O₂.

The concentration of the low valent metal ions which are introduced into the aqueous solution as catalyst needs to be appropriately selected. In the condition of no low valent metal ions, H₂O₂ is difficult to decompose to generate hydroxyl radicals; when the concentration of low valent metal ions is too low, both the amount and the generating rate of hydroxyl radicals by decomposing H₂O₂ are low; when the concentration of low valent metal ions is too high, both the amount and the generating rate of hydroxyl radicals by decomposing H₂O₂ are so high that the treated CNTs are consumed in a large amount in a short time. Therefore, there are needs for selecting appropriate concentration of the low valent metal ions, which preferably may be 0.0001 mol/L to 0.1 mol/L, more preferably 0.0001 mol/L to 0.01 mol/L.

The aqueous solution of H₂O₂ may be neutral or acidic, preferably acidic. In the neutral condition, some low valent metal ions tend to generate hydroxide to form colloid or precipitation. For example, under the neutral condition, ferrous ions Fe²⁺ tend to generate Fe(OH)₂ and Fe(OH)₃ colloid and cannot serve as the catalyze for decomposing H₂O₂. When the aqueous solution of H₂O₂ is acidic, the preferable pH value is less then 6, for example 2-5. When the pH value is too low, the concentration of H⁺ in the solution will be very high and for example the reaction of above equation (3) may be suppressed relatively, and Fe³⁺ will not be reduced to Fe²⁺ smoothly and the ability of oxidation of the aqueous solution is reduced. The pH value can be adjusted by adding acid, water or alkali into the aqueous solution, in which the acids are, for example, H₂SO₄, HCl, HNO₃ and the like, and the alkalis are, for example, NaOH and the like.

During the treatment for the CNTs, the reaction temperature may be less than the boiling point of the aqueous solution, preferably from room temperature to less than 100° C., for example 50-70° C.

In the method according to the first embodiment, additional fresh H₂O₂ is added to the aqueous solution of H₂O₂ at a predetermined interval to keep the content of the hydroxyl radicals stable in the aqueous solution in order to obtain a better treatment effect.

The CNTs to be treated may be prepared by the conventional methods such as arc-discharging method, CVD method, and laser evaporation method. The method according to an embodiment is not limited to the methods for preparing CNTs to be treated. In addition, the CNTs to be treated may be SWNTs, DWNTs or other MWNTs with lager number of walls, and the CNTs include metallic CNTs and semiconducting CNTs mixed together.

In the above methods for preparing CNTs, nanoparticles of the catalyst such as Fe, Co or Ni or their mixture with rare earth elements are conventionally used as catalyst to synthesis CNTs, and these catalyst powders generally remain in the product after the end of the reaction. In addition, in the resulting product, there are a certain amount of impurities such as amorphous carbon, carbon nanoparticles and other graphite debris. If the content of impurities in the product is too high, purification normally needs to be performed on the resulting product to remove the catalyst particles and the above mentioned impurities. In the related art, the normally used purification methods include liquid phase oxidation and gas phase oxidation.

The above metal nanoparticles such as Fe, Co or Ni that are used during the synthesis of CNTs and remained in the product may be used to generate the catalyst for decomposing H₂O₂ to obtain hydroxyl radicals in the method of the first embodiment. Here, the content of the metal particles remained in the CNTs to be treated is preferably less than or equal to 4 wt % and larger than or equal to 0.03 wt %, for example 1 wt %. In order to control the content of the metal particles remained in the CNTs to be treated, the CNTs may be pre-purified to reduce the content of the metal catalyst particles and reduce the content of the impurities such as amorphous carbon and carbon nanoparticles as well.

The content of metallic CNTs in the treated CNTs can be increased through the method for treating CNTs according to the first embodiment. That is, the ratio of the metallic CNTs in the treated CNTs can be improved, meanwhile the treatment presents selectivity on the diameters of the CNTs. The treatment can further reduce or substantially remove the impurities such as amorphous carbon, carbon nanoparticles and other debris contained in the CNTs.

### Example 1

6 mg HiPco-SWNTs purchased from Carbon Nanotechnologies Inc. (USA) are dispersed in a fresh mixed solution of H₂O₂ (30 wt %, 10 ml) and H₂SO₄ (96 wt %, 40 ml) in an ultrasonic bath at the room temperature. The dispersion is then stirred in a preheated water bath at 70° C., small aliquots (about 1 ml) of the sample solution are then collected after a predetermined interval, and the remainder is collected finally when the treatment is ended. About 0.03 wt % Fe nanoparticles used to produce Fe²⁺ ions as catalyst are included in the above HiPco-SWNTs, i.e., in the example, Fe²⁺ ions are obtained by the reaction between the Fe particles in the Hipco-SWNTs and H⁺ (H₂SO₄) in the mixed solution, but not by directly introducing Fe²⁺ ions from the outside, so that the treat process can be simplified.

Each collected sample is immediately diluted with copious amounts of purified water and filtered. The resulting products are ultrasonically dispersed and rinsed with deionized water. The resulting suspensions are centrifuged (14000 rpm for about 10 min) and the supernatant solutions are decanted off. The precipitations are re-suspended in ethanol, three times centrifuged and dried under vacuum to remove the water and other solvent. Finally, about 3.4 mg treated sample is obtained, that is, the yield of about 57% is obtained.

Next, the resulting treated samples are analyzed.

Testing and Analysis

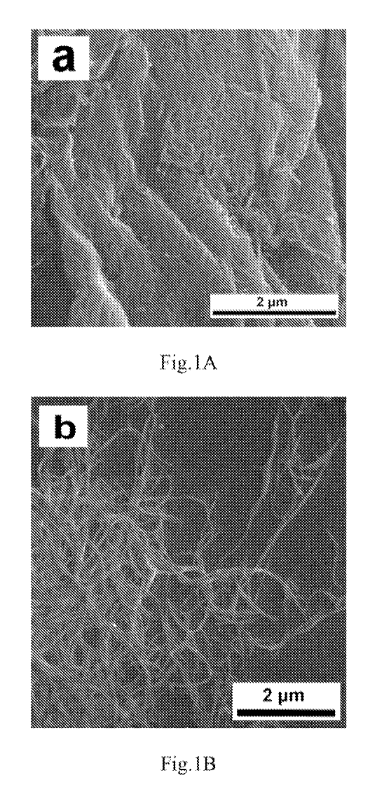

FIG. 1A and FIG. 1B show the SEM photos of the starting SWNTs and the SWNTs which are treated with H₂O₂ and H₂SO₄ for 2 hours at 70 degree Celsius, respectively.

From the comparison between the photos of the starting SWNTs and the SWNTs which are treated with H₂O₂ and H₂SO₄ shown in the FIG. 1A and FIG. 1B, it can be observed that the starting SWNTs contain impurities such as amorphous carbon or graphite impurities. After 2 hours, the treated SWNTs have higher degrees of purity, indicating that the SWNTs after treatment with H₂O₂ and H₂SO₄ are converted into gas such as CO₂ or CO, meanwhile, the impurities are removed and the SWNTs are purified.

In addition, the physical characteristics of the resulting SWNTs treated by the above example is analyzed with Raman spectra and vis-NIR absorption spectra.

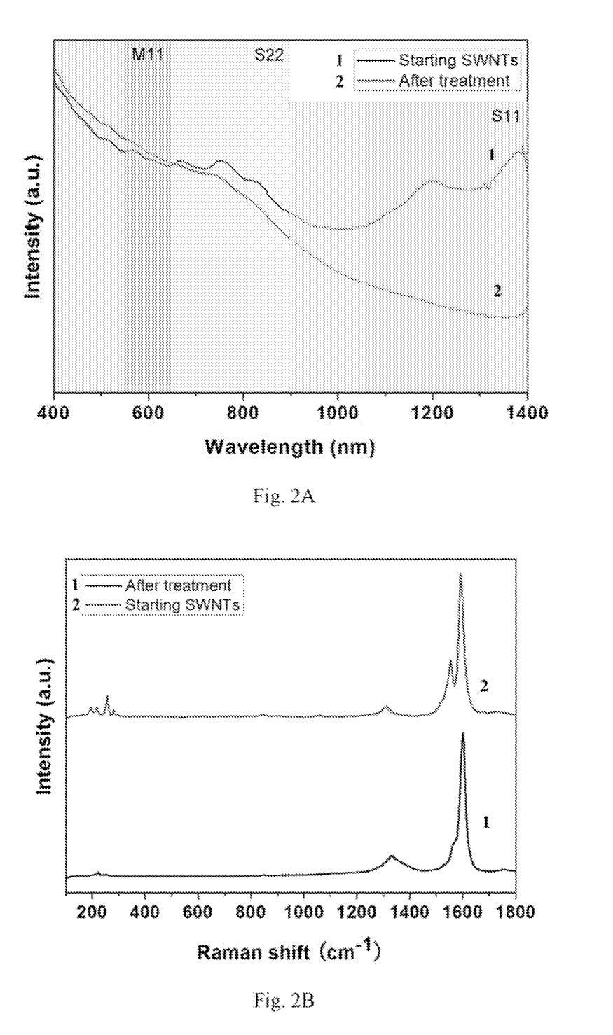

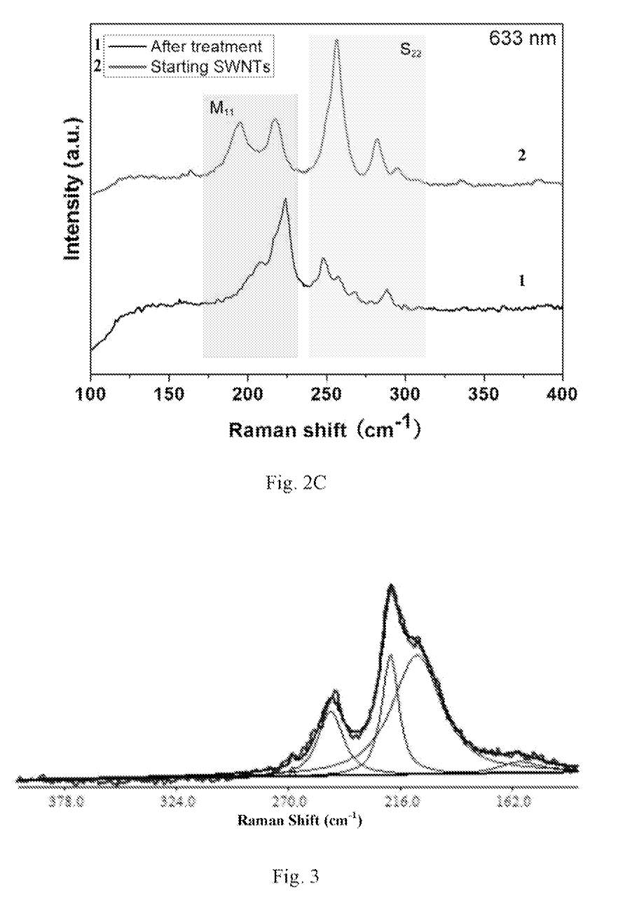

FIG. 2A shows the vis-NIR absorption spectra of the starting SWNTs and the SWNTs which are treated with H₂O₂ and H₂SO₄ for 2 hours at 70 degree Celsius. Three regions are identified in FIG. 2A: first interband transitions for metallic CNTs, M11 (400-650 nm); and first and second interband transitions for semiconductive CNTs, S11 (900-1600 nm) and S22 (550-900 nm). Remarkably, the treated SWNTs have stronger absorption peaks in the metallic M11 band and weaker absorption peaks in the semiconducting S11 and S22 bands than the starting SWNTs, indicating enrichment of metallic SWNTs after treatment. The selective decay of semiconducting absorption bands and the enhancement of metallic absorption bands in H₂O₂—H₂SO₄-treated SWNTs demonstrate that the oxidation process is selective.

Raman spectrum is a powerful tool for the characterization of SWNTs, from which their diameter and electrical properties can be known. When the Raman spectrum testing is performed, in order to exclude the influence of the aggregation of the SWNTs on the results, all the samples used in the Raman spectrum testing may be treated as follows: ultrasonic treatment is performed in ethanol for 5 minutes or more, and then the resulted suspensions are dropped onto the glass sheet and dried in air.

In Raman spectrum, Radial-Breathing Mode (RBM) corresponding to one of the feature diffraction mode of the SWNTs appears in the low frequency of 130 cm⁻¹ to 350 cm⁻¹. The frequency of the RBM mode is inversely-proportional to the diameter of the SWNTs, and the relation can be expressed as ω=223.75/d+6.5 (for example, refer to Lyu, S. C.; Liu, B. C.; Lee, T. J; Liu, Z. Y, Yang, C. W.; Park, C. Y.; Lee, C. J., Chem. Commun. 2003, 734), wherein, ω is RBM frequency with cm⁻¹ as unit, d is the diameter of the SWNTs with nm as unit, and the aggregation effect is also considered therein. The RBM frequency of 130 cm⁻¹ to 350 cm⁻¹ corresponds to the diameter of 0.6 nm to 1.8 nm. The shoulder peak of 1552 cm⁻¹ appearing at the left of the main peak of 1586 cm⁻¹ (G Band) is attributed to the split of the E_{2g} mode of the graphite. Moreover, the shoulder peak is also one of the feature diffraction mode of the SWNTs (for example, refer to A. Kasuya, Y. Sasaki, Y. Saito, K. Tohji, Y. Nishina, Phys. Rev. Lett. 1997, 78, 4434). In addition to these feature peaks, the peak appearing at 1320 cm⁻¹ corresponds to the mode induced by the defect, i.e., D band, and this corresponds to the defects of amorphous carbon and the like included in the sample. Moreover, the G/D ratio is the indicator for evaluating the purity of the SWNTs, and the ratio is increased with the increase of the purity of the SWNTs (for example, refer to H. Kataura, Y Kumazawa, Y Maniwa, Y Ohtsuka, R. Sen, S. Suzuki, Y Achiba, Carbon 2000, 38, 1691).

FIGS. 2B and 2C show the diagrams of the Raman spectra of the starting SWNTs and the SWNTs which are treated with H₂O₂ and H₂SO₄ for 2 hours at 70 degree Celsius (the Raman analyzer is JY LabRam HR800). Raman spectra of starting SWNTs and the treated SWNTs are measured at the excitation wavelength of 632.8 nm, as shown in FIG. 2B. The starting SWNTs have weak but apparently broad Raman peak around 1550 cm⁻¹, which is a Breit-Wigner-Fano (BWF) component due to the resonance of the metallic SWNTs. As shown in FIG. 2B, G/D values almost do not increase after the H₂O₂—H₂SO₄ treatment. This means that defects in SWNTs are not much induced by the treatment. This is understandable because the most of the defective SWNTs should burn more rapidly than the ones without defects. A detailed comparison can be made from the RBM section (FIG. 2C). The starting SWNTs' spectrum shows two bands, with one band (M11) consisting of two peaks at 194 and 217 cm⁻¹ that are assigned to metallic SWNTs and the other band (S22) dominated by a feature at 255 and 288 cm⁻¹ that are assigned to semiconducting SWNTs. Obviously, the strong peak at 255 cm⁻¹ in the starting SWNTs becomes a small one. The RBM section of the Raman spectra excited at the excitation wavelength of 514.5 nm is depicted in FIG. 3. The concentration of the metallic SWNTs in the sample is estimated from the Raman spectra. An integrated intensity ratio of the Raman bands M11 (170-240 cm⁻) and S22 (240-300 cm⁻¹), M11/(M11+S22), is estimated as the concentration of the metallic CNTs.

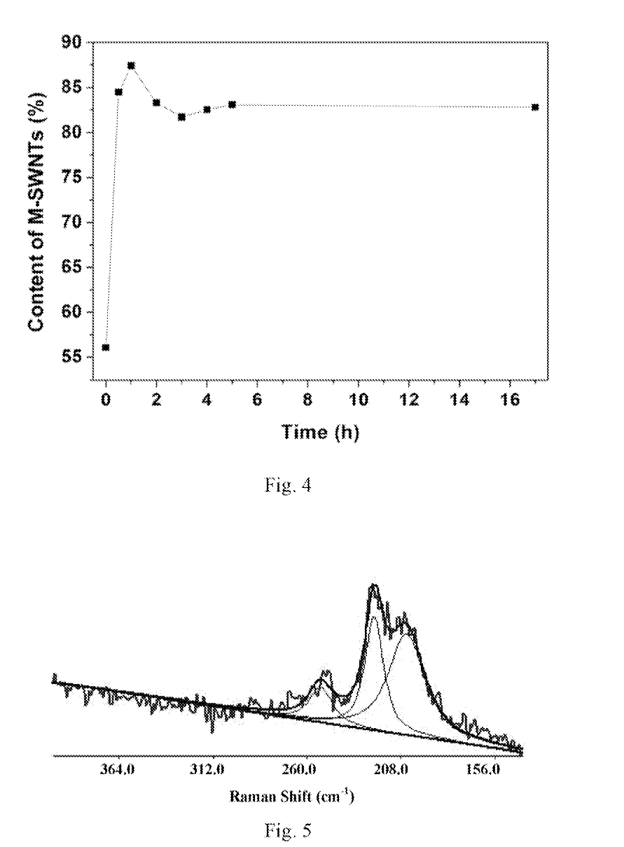

FIG. 4 is the diagram showing how the content of the metallic SWNTs treated in the single step treatment changes with the time. As shown in FIG. 4, in the beginning of reaction, the concentration of metallic SWNTs is sharply increased from about 56% in the starting SWNTs to about 87%. After 1 hour, the concentration of metallic SWNTs falls after the rise. When the SWNTs have been treated for about 4 hours to 5 hours, the concentration starts to keep at a steady level. Hence, it is difficult to further enrich the metallic SWNTs only by prolonging the treat time. In fact, a treatment of overly long time will consume more SWNTs so as to reduce the yield, and the enrichment of metallic SWNTs is a fast process.

After the H₂O₂—H₂SO₄ treatment, most of the M1 RBM peaks in FIG. 3 survive, while the most intensive RBM peaks of the S3 band at 255 cm⁻¹, 288 cm⁻¹ in FIG. 3 are decreased drastically after the H₂O₂—H₂SO₄ treatment, and the main component is changed to 250 cm⁻¹. This result means that the diameter distribution of semiconducting SWNTs has been strongly modified by the H₂O₂—H₂SO₄ treatment. In the rough diameter estimation from the RBM spectra, the mean diameter of semiconducting SWNTs changes from 1.0 to 1.2 nm, and at the same time the metallic SWNTs are changed to slightly larger diameters.

In addition, a multi-step treatment with short intervals between steps is performed to further improve the extent of increasing of the content of metallic SWNTs.

### Example 2

The aspects such as reaction condition and the CNTs to be treated of Example 2 are the same as those of Example 1, except that after starting the treatment, fresh H₂O₂ (H₂O₂—H₂SO₄ mixture) is added into the reaction system (the acidic aqueous solution of H₂O₂) every 1 hour to maintain the content of H₂O₂ in the reaction system.

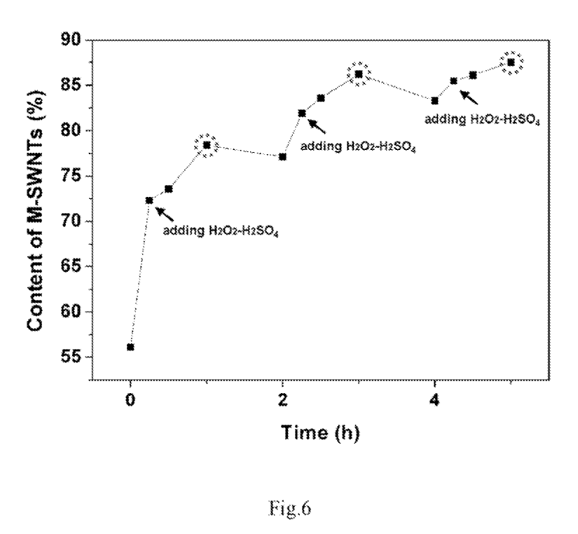

FIG. 5 is the Raman spectra of the samples after adding H₂O₂ and H₂SO₄ for 3 times in the multiple-step treatment. FIG. 6 is the diagram showing how the content of the metallic CNTs treated in the multiple-step treatment changes with the time. As shown in FIG. 6, in the case that the fresh H₂O₂—H₂SO₄ mixture is periodically added into the reaction system, the content of metallic CNTs in the samples is gradually increased after every time the fresh H₂O₂ is added into the reaction system. After the fresh H₂O₂ has been added for 3 times, the content of metallic CNTs in the resulted product reaches up to about 88%. As shown in FIG. 5, the Raman spectra of the sample after adding H₂O₂ and H₂SO₄ for 3 times indicate that the concentration of metallic SWNTs is further increased.

The testing and analyzing results of the above Example 1 and Example 2 indicate that the semiconducting SWNTs are selectively removed by the hydroxyl radicals in the H₂O₂—H₂SO₄ treatment.

In the above examples, in order to obtain the low valent ions of the metal (for example, Fe, Co and/or Ni particles contained in the CNTs to be treated) in the aqueous solution, H₂SO₄ is effectively used. Furthermore, heat will be released when H₂SO₄ mixes with H₂O₂, which is favor to accelerate the reaction rate but will not make the CNTs over oxidized. Similarly, the normally used acids such as HNO₃ and HCl may be employed, as long as the acid can generate the low valent ions used as catalyst with the metal and further decompose H₂O₂ to generate hydroxyl radicals, and therefore the present application is not limited to the specific acid added.

Although the above embodiment is described with the SWNTs that are treated, it should be understood for those skilled in the art that the treatment method of the present application has the same treatment effect on those MWNTs, especially for the MWNTs with small diameter and relatively small number of wall layers (for example, two layers or three layers). The method of the present application can be used to separate metallic MWNTs from semiconducting MWNTs and present a diameter selectivity.

### The Second Embodiment

In a second embodiment, the CNTs treated by the treatment method are used to fabricate CNT conductive film.

CNT conducting films, including CNT networks, particularly of SWNT networks, have recently attracted much attention because individual CNT's variation such as diameter and chirality can be suppressed by the ensemble averaging over a great number of CNTs. The conductivity of the film can be determined by many factors such as contact resistance between CNTs and metallic CNT content in the network. Therefore, in order to obtain the CNT film with high conductivity, it is needed to minimize the contact resistance between CNTs and to increase the content of metallic CNTs in the network. Therefore, the CNT transparency conducting films can be fabricated using the treated CNT according to an embodiment.

The CNT conductive film according to the second embodiment can be fabricated as follows. First, 1 mg of CNTs treated by the method of the embodiment is dispersed in 50 ml of 1.0 wt % sodium dodecyl sulfate (SDS) with ultrasonic for 20 minutes. The solution is centrifuged at 50,000 g at 25° C. for 1 hour, and the upper clear part of the solution is vacuum filtered through a mixed cellulose ester membrane filter. As the solution falls through the pores in the membrane filter, the CNTs are trapped on the surface of the membrane filter, forming a CNT film. The residual SDS in the film is washed away with distilled water.

The CNT film with the membrane filter is placed in contact with the quartz substrate. The membrane filter is covered with porous paper and a flat glass plate, which are compressively loaded to keep the film flat when dried at 90° C. in less than 10² Pa (=1 mbar) for 1 hour. The membrane filter is removed by dipping in acetone, and then the CNT film is heated at 150° C. in less than 10² Pa for 5 hours to remove acetone and to improve adhesion of the film on the substrate. The film is finally heated at 900° C. in less than 10⁻² Pa for 30 minutes.

As described above, the content of metallic CNTs in the CNTs treated with the method of an embodiment can be remarkably increased for example up to 88%, and therefore the CNT conductive film with increased sheet resistance can be obtained.

### The Third Embodiment

In a third embodiment, the CNTs treated with the method are used to fabricate the CNT film suitable for field emission source of the filed emission device (FED) and used in a FED. The fabrication of the CNTs film can be done as follows, for example.

The CNTs treated according to an embodiment are dispersed in ethanol with ultrasonic for 5 hours, and then the ethanol is removed through volatilization. The mixture of terpilenol and cellulose with mass ratio of 95%:5% is used as organic solvent and is mixed with the dispersed CNTs to obtain slurry for silk screen printing, in which the mass ratio between the organic solvent and CNTs is, for example, 3:2. The slurry is printed on a glass substrate by silk screen printing to form the desired pattern, and then is sintered. Subsequently, the sintered CNTs are activated. First, the surface of the CNT film is slightly polished or etched and the terminals of the CNTs are exposed; then, ion etching may be performed on the CNTs to increase the ability for emitting electrons. In order to ensure the conductivity of the thin film of CNTs, silver powder may be added into the slurry for printing.

In the FED, the CNTs serve as the cathode and the indium tin oxide (ITO) thin film coated with a layer of fluorescent powder serves the an anode, and the cathode and the anode are separated from each other by about 15 mm with barrier ribs disposed therebetween. Under the control of control circuit, for example, a voltage can be applied between the cathode and the anode, the electrons can be emitted from the CNTs as the cathode, and the emitted electrons are forced to the anode and activate the fluorescent layer to display image.

With the treatment method according to an embodiment, the separation for CNTs of different conductivity is performed and the metallic CNTs can be enriched, and hence the enriched metallic CNTs can be further used for various electronic devices, for example, conductive film and field emission source and also can be used in other types of CNT device, such as, a filed effect transistor, a conductive wire, a spin conduction device, a nano electro-mechanic system (NMES), a nano cantilever, a quantum computing device, a lighting emitting diode, a solar cell, a surface-conduction electron-emitter display, a filter (e.g., high-frequency or photonic band), a drag delivery system, a space elevator, a thermal conductive material, a nano nozzle, an energy storage system, a fuel cell, a sensor (e.g., a gas, glucose, or ion sensor), or a catalyst support material, which use the treated CNTs according to the present application. Another embodiment relates to using the above treated CNTs to fabricate carbon nanotube devices.

The treatment method according to an embodiment at least can have the following advantages: first, comparing with the related art, the method according an embodiment can greatly increases the yield of the treatment, for example, up to 57%; secondly, comparing with the related art, the method according an embodiment enriches the metallic CNTs more effectively, for example, up to 88%; third, the treatment method of the present application does not need the complicated post-treatment such as centrifugal separation; and forth, the impurities such as amorphous carbon can be removed in the reaction and thus purify the CNTs.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of treating carbon nanotubes, comprising treating the carbon nanotubes with an aqueous solution containing hydroxyl radicals.

2. The method of claim 1, wherein the hydroxyl radicals are obtained by decomposing hydrogen peroxide in the aqueous solution.

3. The method of claim 2, wherein low valent metal ions are used as catalyst to decompose the hydrogen peroxide in the aqueous solution to obtain the hydroxyl radicals.

4. The method of claim 3, wherein the low valent metal ions comprise bivalent ions of Fe, Co, or Ni.

5. The method of claim 3, wherein the low valent metal ions in the aqueous solution have a concentration ranging from 0.0001 mol/L to 0.01 mol/L.

6. The method of claim 3, wherein the aqueous solution has a pH value of less than 6.

7. The method of claim 3, wherein the hydrogen peroxide in the aqueous solution has a concentration ranging from lwt % to 30 wt %.

8. The method of claim 3, wherein treating is performed at a temperature ranging from room temperature to 100 degree Celsius.

9. The method of claim 3, wherein additional hydrogen peroxide is added into the aqueous solution at a predetermined interval during treatment.

10. Carbon nanotubes produced by the method of claim 1.

11. A carbon nanotube device, comprising carbon nanotubes produced by the method of claim 1.

12. The carbon nanotube device of claim 11, wherein the carbon nanotube device comprises CNT conductive film, field emission source, transistor, conductive wire, electrode material, nano electro-mechanic system (NEMS), nano cantilever, quantum computing device, lighting emitting diode, solar cell, surface-conduction electron-emitter display, filter, drag delivery system, thermal conductive material, nano nozzle, energy storage material, fuel cell, sensor, or catalyst support material.
